(19) United States
(12) Patent Application Publication
(10) Pub. No.: US 2025/0185018 A1
(43) Pub. Date: Jun. 5, 2025

(54) MULTIPLE TRANSMISSION AND RECEPTION (TRP) OPERATIONS BASED ON MULTIPLE TIMING ADVANCES (TAS)

(71) Applicant: Apple Inc., Cupertino, CA (US)

(72) Inventors: Haitong Sun, Saratoga, CA (US); Ankit Bhamri, Haar Bavaria-Bayern (DE); Dawei Zhang, Saratoga, CA (US); Hong He, San Jose, CA (US); Oghenekome Oteri, San Diego, CA (US); Wei Zeng, Saratoga, CA (US); Xiang Chen, Campbell, CA (US)

(73) Assignee: Apple Inc., Cupertino, CA (US)

(21) Appl. No.: 18/817,044

(22) Filed: Aug. 27, 2024

Related U.S. Application Data
(60) Provisional application No. 63/604,845, filed on Nov. 30, 2023.

(51) Int. Cl. H04W 72/231; H04W 52/14; H04W 52/24; H04W 56/00; H04W 72/51

(52) U.S. Cl. CPC H04W 72/231; H04W 52/146; H04W 52/242; H04W 56/0045; H04W 72/51

(57) ABSTRACT

The present application relates to uplink transmission using multiple TAs. In an example, a base station can configure a UE to use multiple TAGs in association with a non-unified TCI framework and/or a single DCI multi-TRP operation. Subsequently, the base station sends signaling information to the UE. The signaling information can activate TCI state(s) for a multi-TRP uplink transmission and/or schedule the multi-TRP uplink transmission. Based on the signaling information and the configuration information, the UE determines a first TAG to use for the first uplink transmission and a second TAG to use for the second uplink transmission. Based on these two TAGs, the UE determines a first TA to use for a first uplink transmission to a first TRP and a second TA to use for a second uplink transmission to a second TRP.

### CROSS-REFERENCES TO RELATED APPLICATIONS

This application claims the benefit to U.S. Provisional Application No. 63/604,845, filed Nov. 30, 2023, entitled “MULTIPLE TRANSMISSION AND RECEPTION (TRP) OPERATIONS BASED ON MULTIPLE TIMING ADVANCES (TAS),” the disclosures which is incorporated by reference in its entirety.

### BACKGROUND

Fifth generation mobile network (5G) is a wireless standard that aims to improve upon data transmission speed, reliability, availability, and more. This standard, while still developing, includes numerous details related to, for instance, a user equipment (UE) communicating with a transmission and reception point (TRP) of a network to send and receive data. The communication can rely over one or more channels available from one or more beams provided by the TRP and detected by the UE.

### BRIEF DESCRIPTION OF THE DRAWINGS

FIG. 1 illustrates an example of a network environment, in accordance with some embodiments.

FIG. 2 illustrates an example of a cell that includes multiple transmission and reception points (TRPs), in accordance with some embodiments.

FIG. 3 illustrates an example of propagation delays associated with multiple TRPs, in accordance with some embodiments.

FIG. 4 illustrates an example of multiple timing advances (TAs) used for uplink transmissions to multiple TRPs, in accordance with some embodiments.

FIG. 5 illustrates an example of a sequence diagram for using multiple TAs, in accordance with some embodiments.

FIG. 6 illustrates an example of configuring a user equipment (UE) to use multiple TAs, in accordance with some embodiments.

FIG. 7 illustrates another example of configuring a UE to use multiple TAs, in accordance with some embodiments.

FIG. 8 illustrates another example of configuring a UE to use multiple TAs, in accordance with some embodiments.

FIG. 9 illustrates an example of a media access control (MAC) control element (CE) for indicating TAs to use with physical uplink control channel (PUCCH) transmissions, in accordance with some embodiments.

FIG. 10 illustrates an example of a MAC CE for indication TA to use with sounding reference signal (SRS) transmissions, in accordance with some embodiments.

FIG. 11 illustrates an example of single downlink control information (DCI) in muti-TRP transmission indicating TAs to use, in accordance with some embodiments.

FIG. 12 illustrates examples of handling collisions due to the use of multiple TAs, in accordance with some embodiments.

FIG. 13 illustrates an example of an operational flow/algorithmic structure for a UE to use multiple TAs, in accordance with some embodiments.

FIG. 14 illustrates an example of an operational flow/algorithmic structure for a base station to configure a UE to use multiple TAs, in accordance with some embodiments.

FIG. 15 illustrates an example of receive components, in accordance with some embodiments.

FIG. 16 illustrates an example of a UE, in accordance with some embodiments.

FIG. 17 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) can communicate with a network, such as with a transmission and reception point (TRP) of a cell. To improve data throughput, a multiple input multiple output (MIMO) implementation can be used, where the UE can communicate with two or more TRPs of the cell. In the MIMO implementation, the communication with a TRP can rely on one or more channels that are available from the TRP and detected by the UE. Given a relative location between the UE and each TRP, different propagation delays can exist. As such, if the UE sends simultaneous transmissions to the TRPs, the receptions by the TRPs of such transmissions may not be time-synchronized due to the different propagation delays.

To address such and other challenges, embodiments of the present disclosure involve using multiple timing advances (TAs). For example, the UE can send a first uplink transmission to a first TRP and a second uplink transmission to a second TRP. However, the two uplink transmissions can be based on two different timing advances that account for the propagation delays between the UE and the two TRPs.

To enable the multi-TA use, a base station that includes the two TRPs can send configuration information to the UE. This configuration information indicates TA groups (TAGs) and is usable with a non-unified transmission configuration indication (TCI) framework and/or a single downlink control information (DCI) multi-TRP operation. Subsequently, the base station sends signaling information to the UE. The signaling information can activate TCI state(s) for a multi-TRP uplink transmission and/or schedule the multi-TRP uplink transmission. For example, the signaling information includes a media access control element (MAC) control clement (CE) that activates the TCI state(s) and/or a single DCI for the multi-TRP uplink transmission. Based on the signaling information and the configuration information, the UE determines a first TAG to use for the first uplink transmission and a second TAG to use for the second uplink transmission. Based on these two TAGs, the UE determines a first TA to use for the first uplink transmission and a second TA to use for the second uplink transmission.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or digital signal processors (DSPs) that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “TRP” as used herein refers to a device with radio communication capabilities that is a network node of a communications network (or, more briefly, network) and that may be configured as an access node in the communications network. A UE's access to the communications network may be managed at least in part by the TRP, whereby the UE connects with TRP to access the communications network. Depending on the radio access technology (RAT), the TRP can have a number of transmit and receive antenna elements generating directional beams.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during execution of program code.

The term “connected” may mean that two or more elements at a common communication protocol layer have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

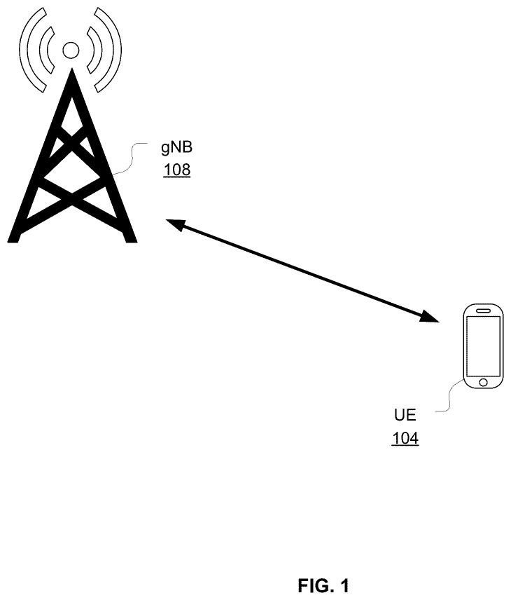

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications, such as those that define Fifth Generation (5G) NR system standards. As further described in the next figures, the gNB 108 can be deployed as a TRP in a cell that includes multiple TRPs.

The gNB 108 may transmit information (for example, data and control signaling) in the downlink direction by mapping logical channels on the transport channels and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in an SSB. The SSBs may be used by the UE 104 during a cell search procedure (including cell selection and reselection) and for beam selection.

The PDSCH may be used to transfer end-user application data, signaling radio bearer (SRB) messages, system information messages (other than, for example, MIB), and SIs.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include a channel status information reference signal (CSI-RS). The CSI-RS may be a multi-purpose downlink transmission signal that may be used for CSI reporting, beam management, connected mode mobility, radio link failure detection, beam failure detection and recovery, and fine-tuning of time and frequency synchronization. Similarly, the UE can transmit reference signals to the gNB 108 for measurements to be performed by the gNB 108 (e.g., in use cases where reciprocity is not assumed between a downlink channel and an uplink channel). These reference signals can include, for example, a sounding reference signal (SRS).

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain and one OFDM symbol in the time domain, for example, twelve resource elements. A control channel element (CCE) may represent a group of resources used to transmit PDCCH. One CCE may be mapped to a number of REGs, for example, six REGs.

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data) and can carry UCI.

The UE 104 and the gNB 108 may perform beam management operations to identify and maintain desired beams for transmission in the uplink and downlink directions. The beam management may be applied to both PDSCH and PDCCH in the downlink direction and PUSCH and PUCCH in the uplink direction.

In an example, communications with the gNB 108 and/or the base station can use channels in the frequency range 1 (FR1), frequency range 2 (FR2), and/or a higher frequency range (FRH). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

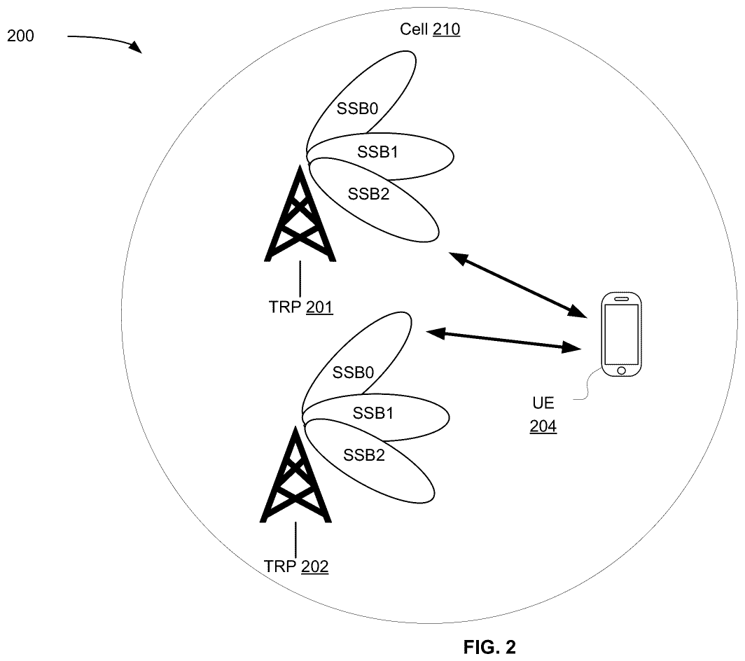

FIG. 2 illustrates an example 200 of a cell 210 that includes multiple TRPs, in accordance with some embodiments. In the illustration, the cell 210 includes two TRPs: a first TRP 201 and a second TRP 202 associated with a same base station (e.g., the gNB 108). Nonetheless, a larger number of TRPs per base station is possible. Generally, the cell 210 is a serving cell that enables MIMO communications, where a UE 204 (e.g., the UE 104) can simultaneously communicate with the TRP 201 and the TRP 202 to simultaneously transmit and/or simultaneously receive information (e.g., traffic data). Each TRP of the cell 210 can transmit multiple directional beams (FIG. 2 illustrates three beams labeled as synchronization signal blocks (SSBs) “0” through “2”, although a different number of directional beams is possible) and can extend to cover an area around the TRP. Based on beam measurements, such as reference signal received power (RSRP) and/or reference signal received quality (RSRQ), the UE 204 can select a particular beam transmitted by a TRP in support of the communication therewith. In the illustration of FIG. 2, the UE 204 communicates with the TRP 201 using SSB2 and with the TRP 202 using SSB0.

In the case of carrier aggregation, the network can configure the cell 210 as a PCell or an SCell. In the case of dual connectivity, the network can configure the cell 210 as a PCell, a PSCell, or an SCell. An SpCell refers to either a PCell or a PSCell.

The network can configure the UE 204 to communicate with the TRP 201 and the TRP 202 by sending configuration information (e.g., via RRC signaling) to the UE 204 as further described herein below. Once the UE 204 is configured, the UE 204 can determine based on the configuration information and, possibly, based on other signaling information (e.g., via MAC CE and/or DCI) timing advances to perform uplink transmissions to the TRP 201 and the TRP 202 as further described herein below.

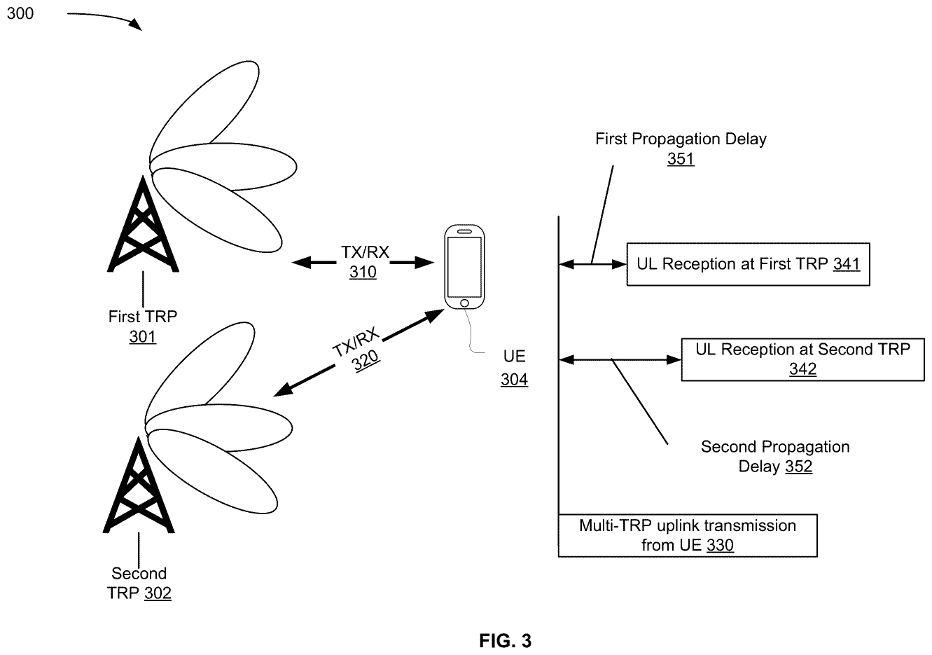

FIG. 3 illustrates an example 300 of propagation delays associated with multiple TRPs, in accordance with some embodiments. Like in the illustration of FIG. 2, a UE 304 (e.g., the UE 104) can communicate with a first TRP 301 (e.g., the TRP 201) and a second TRP 302 (e.g., the TRP 202) associated with a same base station (e.g., the gNB 108). The communications can include uplink transmissions and downlink receptions 310 between the UE 304 and the first TRP 301 and uplink transmissions and downlink receptions 320 between the UE 304 and the second TRP 302. The uplink transmissions from the UE 304 to the first TRP 301 can possibly be simultaneous with the uplink transmission from the UE 304 to the second TRP. Similarly, the downlink receptions to the UE 304 from the first TRP 301 can possibly be simultaneous with the downlink receptions to the UE 304 from the second TRP 302.

In the illustration of FIG. 3, the UE 304 does not use any TAs for a multi-TRP uplink transmission 330 (e.g., the uplink transmissions to the first TRP 301 and to the second TRP 302). Alternatively, the same TA is used for the multi-TRP uplink transmission 330. In both cases, a first propagation delay 351 exists for a first uplink transmission from the UE 304 to the first TRP 301, and a second propagation delay 352 exists for a second uplink transmission from the UE 304 to the second TRP 302. Due to different factors (e.g., the relative location of the UE 304 to each of the two TRPs 301 and 302), the two propagation delays 351 and 352 can be different. As a result, the first TRP 301 can receive the first uplink transmission (this reception is shown as a UL reception 341 in FIG. 3) at a first time and can receive the second uplink transmission (this reception is shown as a UL reception 342 in FIG. 3) at a second time that is different from the first time. In other words, the two receptions may not be time-synchronized, which can result in a quality degradation of the multi-TRP communications.

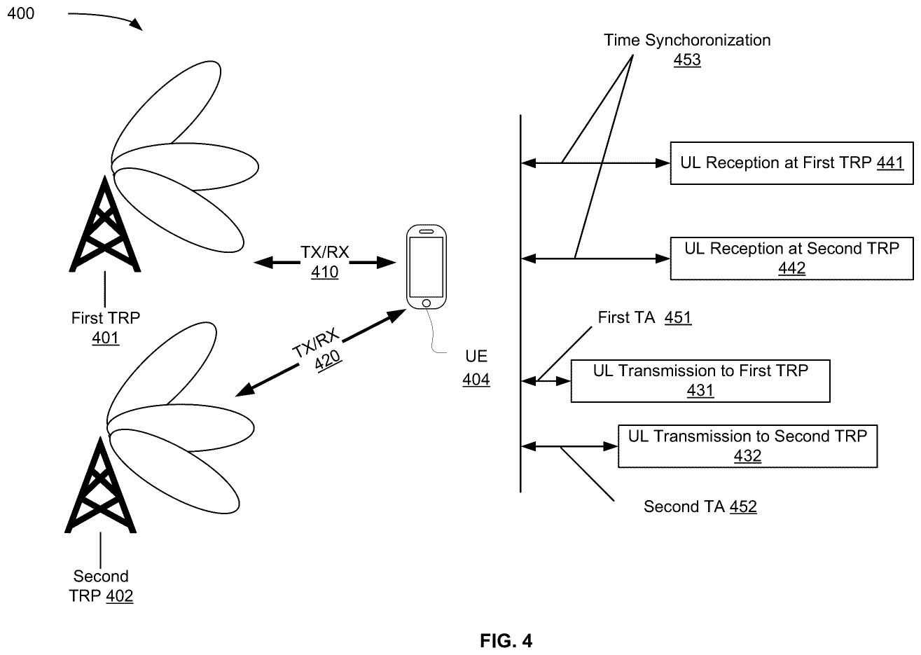

FIG. 4 illustrates an example of multiple TAs used for uplink transmissions to multiple TRPs, in accordance with some embodiments. Like in the illustration of FIG. 3, a UE 404 (e.g., the UE 104) can communicate with a first TRP 401 (e.g., the TRP 301) and a second TRP 402 (e.g., TRP 402) associated with a same base station (e.g., the gNB 108). The communications can include uplink transmissions and downlink receptions 410 between the UE 404 and the first TRP 401 and uplink transmissions and downlink receptions 420 between the UE 404 and the second TRP 402. The UE can perform a multi-TRP transmission, such as a first uplink transmission 431 to the first TRP 401 simultaneous with a second uplink transmission 432 to the second TRP 402.

In an example, the first uplink transmission 431 is associated with a first TA 451, whereas the second uplink transmission 432 is associated with a second TA 452. The two TAs 451 and 452 are different such that, the first TRP 401 can receive the first uplink transmission 431 (this reception is shown as a UL reception 441 in FIG. 4) at the same time (e.g., in a time-synchronized manner, shown as time synchronization 453 in FIG. 4) with the reception of the second uplink transmission 432 (this reception is shown as a UL reception 442 in FIG. 4). In other words, the two TAs 451 and 452 account for the different propagation delays to result in the time synchronization 453.

Generally, an uplink transmission can be scheduled by the base station (e.g., via DCI and/or upon an uplink grant). The scheduling can indicate (or the UE can determine) the timing (e.g., a slot and a symbol in a slot on an uplink channel) to start the uplink transmission. This timing can be scheduled (or determined by the UE) based on many parameters, including the TA to use.

Rather than maintaining a TA per cell, a set of collocated cells can be grouped in a same TAG associated with a TA, so that the TA applies to the cells belonging to that group. A TAG can be associated with one or more cells and a TA applicable thereto. The mapping of cell(s) to the TAG is configured by RRC. Multiple TAGs (e.g., up to four) can also be configured via RRC.

In the multi-TRP situations, the maximum transmit timing difference (MTTD) between the different TRPs (e.g., the TRPs 401 and 402) can be more than a duration of a cyclic prefix (CP) for different reasons. One reason is that the timing synchronization error between two or more TRPs is large. Another reason is that the spatial difference between different antenna panels (e.g., of the UE 404) or the different TRPs is large.

To handle such challenges in multiple TRP-situations (including multiple input multiple output (MIMO) implementations), it may be possible to use more than one TA for the different TRPs providing a same cell (e.g., associated with a same base station). For example, a single service cell (e.g., the cell 210 of FIG. 2) can be configured with two or more TAGS.

Referring back to the illustration of FIG. 4, the first TRP 401 and the second TRP 402 are part of the same cell (e.g., the cell 210). The cell can be configured (e.g., via RRC signaling) with two TAGs. This configuration (e.g., TAG configuration) enables the UE to use the first TA 451 and the second TA 452 for the multi-TRP transmission. In particular, the first uplink transmission 431 can be associated with a first TAG of the two configured TAGs, whereas the second uplink transmission 432 can be associated with a second TAG of the two configured TAGs. In turn, the first TAG is associated with the first TA 451, whereas the second TAG is associated with the second TA 452. The first uplink transmission 431 is sent simultaneously with the second uplink transmission 432 based on the first TA 451 and the second TA 452. Simultaneous transmissions can refer to at least some overlap in the time domain (e.g., by at least one symbol) between the transmissions.

Examples of the TAG configuration are further described herein below. Additionally, examples of signaling information to enable the use of multiple TAGs for multiple TRP uplink transmission in association with a non-unified TCI or single DCI multi-TRP uplink transmission are further described herein below.

In the context of an NR network, unified TCI was introduced in Release 17 of the NR standard defined by 3GPP. Legacy TCI refers to TCI that was defined prior to Release 17 and that Release 17 and new releases of the NR standard continue to support. Non-unified TCI is used herein synonymously with legacy TCI (e.g., to indicate that it is not the unified TCI introduced in Release 17, but is TCI predating Release 17). Single DCI for multiple TRP uplink transmission (also referred to as single-DCI multi-TRP operation or single-DCI based multi-TRP operation) was also introduced, wherein the same DCI can indicate parameters for uplink transmissions by a UE to multiple TRPs.

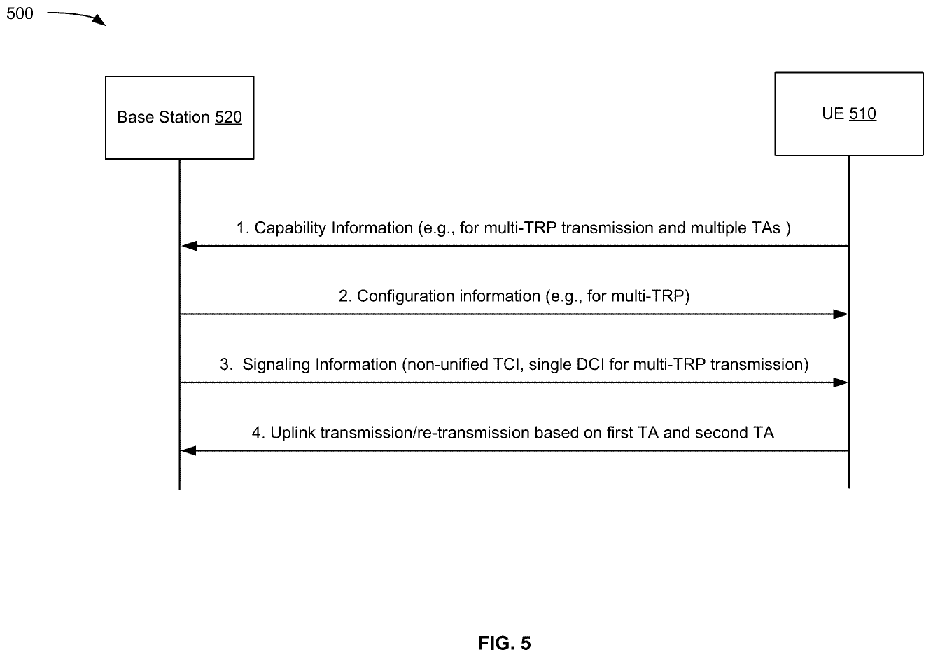

FIG. 5 illustrates an example of a sequence diagram 500 for using multiple TAs, in accordance with some embodiments. In particular, a base station 520 may include K TRPs and a UE 510 may communicate with the K TRPs, where K is a positive integer equal to or greater than two. In a first step of the sequence diagram 300, the UE 510 can send capability information to the base station 520. The capability information can indicate a number of supported features. A first feature can relate to a multiple TRP transmission. For example, the UE 510 can indicate its supports of single-DCI multi-TRP operation, such as any or all of single-DCI multi-TRP STx2P SDM PUSCH, single-DCI multi-TRP STx2P SFN PUSCH, and single-DCI multi-TRP STx2P SFN PUCCH, single-DCI multi-TRP PUSCH/PUCCH repetition, etc., among other examples. A second features can relate to TA. For example, the UE 510 can indicate its support of two TAs (or, more generally, multi-TA) operation for PUSCH and/or PUCCH transmissions. A third feature can relate to a combination of the multi-TRP transmission and the multi-TA operation. For example, the UE 510 can report whether the network can configure two (or more) TAs usable in combination with any or all of the single-DCI multi-TRP STx2P SDM PUSCH, the single-DCI multi-TRP STx2P SFN PUSCH, and the single-DCI multi-TRP STx2P SFN PUCCH, single-DCI multi-TRP PUSCH/PUCCH repetition, etc.

Next, the base station 520 can send configuration information to the UE 510. The configuration information can be based on the capability information. Assuming the UE 510 supports the multi-TRP transmission and the multi-TA operation, the configuration information can relate to the multi-TRP transmission and the multi-TA operation. For example, the configuration information can include a TAG configuration that indicates multiple TAGs. The configuration information can also include TCI configuration that indicates multiple TCI states. The configuration information can also include a power control configuration for uplink transmission (e.g., PUCCH, SRS, and/or PUSCH transmission).

Once the UE 510 is configured, the base station 520 can send signaling information to the UE 510 to trigger the multi-TRP transmission by the UE 510 so that the UE 510 can simultaneously perform uplink transmissions to M of the K TRPs, where M is a positive integer equal to or larger than two and equal to or smaller than K. The signaling information can include, for example, MAC CE (e.g., for activating a configured TCI state associated with one or more configured TAGs) and/or single DCI (e.g., to indicate one or more configured TAGs).

Thereafter, the UE 510 can determine a first TAG to use for first uplink transmissions and transmissions to a first TRP of the M TRPs, a second TAG to use for second uplink transmissions and transmissions to a second TRP of the M TRPs, and so on. The first TAG is a configured TAG that is associated with a first TA. Similarly, the second TAG is a configured TAG that is associated with a second TA. The UE 510 then determines the needed timing adjustment (e.g., equal to the first TA) to transmit the first uplink transmissions, and the needed timing adjustment (e.g., equal to the second TA) to transmit the second uplink transmissions.

In an example, a UE supports a multi-TA operation using a legacy TCI framework (e.g., a non-unified TCI framework) for uplink channels and/or uplink signals such as PUCCH, PUSCH, and/or SRS. In this case, given the different RF properties of FR1 and FR2, a separate solution can be considered for FR1 and FR2. In particular, a spatial relation can be configured for FR2. A TAG index (also referred to herein as a TAG identifier (ID)) can be associated with the spatial relation in, for example, configuration information. For FR1, a spatial relation cannot be configured. Accordingly, a TAG ID cannot be associated with a spatial relation for FR1. Instead, other approaches are possible for FR1, as further described herein below. Such approaches can be implemented for both FR1 and FR2 so that a unified framework becomes possible for both frequency ranges.

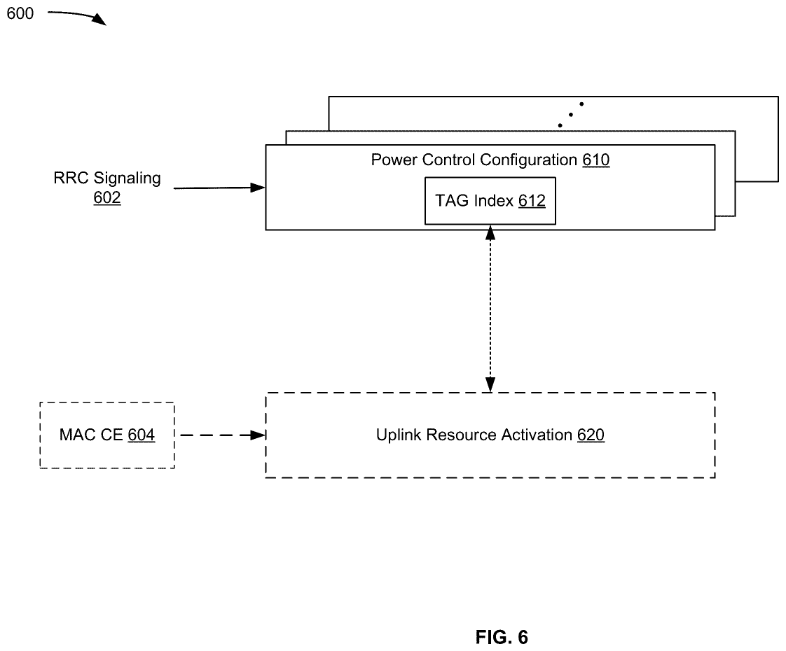

FIG. 6 illustrates an example 600 of configuring a UE to use multiple TAs, in accordance with some embodiments. In an example, a base station configures a UE by sending configuration information to the UE via RRC signaling 602. This configuration information can indicate multiple power control configurations (shown as multiple of a power control configuration 610) for uplink resources (e.g., up to M PUCCH resources, up to N PUSCH resources, and/or up to K SRS resources, where M, N, K can be equal or different, M is equal to sixty-four in one example). Each power configuration 610 can have an index and can include a particular information element (IE) specific for TAGs. The IE in the power control configuration 610 can include a TAG index 612. As such, each power control configuration 610 can link at least a TAG index to at least one uplink resource.

In an example, a MAC CE 604 (or some other signaling information) can be used to activate a configured uplink resource (shown as uplink resource activation 620). In particular, the MAC CE 604 can indicate a power control configuration index to use for a transmission of the uplink resource. The corresponding power control configuration includes an IE that identifies the TAG. This correspondence is shown in FIG. 6 with a dotted, double-sided arrow. Given the TAG index, the UE uses the associated TA in the transmission of the uplink resource. The use of the MAC 604 and the uplink resource activation 620 can be optional (and as such are shown with dashed rectangles in FIG. 6) and can depend on the uplink resource.

To illustrate, consider three examples applicable with a legacy TCI framework: a PUCCH resource, an SRS resource, and a PUSCH resource. In these examples, two TRPs and two TAGs are also illustrated.

Starting with the PUCCH resource, the power control configuration 610 corresponds to a PUCCH power control set information (PUCCH-PowerControlSetInfo). An IE can be added to the PUCCH-PowerControlSetInfo. This IE includes a TAG index (TAGIndex-r19) to indicate the associated TAG (e.g., whether the first TAG, the second TAG is included in the PUCCH-PowerControlSetInfo). An example is as follows:
PUCCH-PowerControlSetInfo-r17 ::=SEQUENCE {
pucch-PowerControlSetInfoId-r17 PUCCH-PowerControlSetInfoId-r17,
p0-PUCCH-Id-r17 P0-PUCCH-Id,
pucch-ClosedLoopIndex-r17 ENUMERATED {i0, i1},
pucch-PathlossReferenceRS-Id-r17 PUCCH-PathlossReferenceRS-Id-r17
TAGIndex-r19 INTEGER (0 . . . 1) OPTIONAL,—Need S
}

For each PUCCH resource, a MAC-CE 604 can be used to activate the PUCCH resource with one or two PUCCH-PowerControlSetInfold. Therefore, the MAC CE 604 indirectly indicates the corresponding one or two TAGs. The direct indication of a TAG is in the PUCCH-PowerControlSetInfo having the corresponding identifier (PUCCH-PowerControlSetInfoId).

In comparison, for the SRS resource, the power control configuration 610 corresponds to a reference signal (RS) configuration for a pathloss reference (PathlossReferenceRS-Config). An IE can be added to the PathlossReferenceRS-Config. This IE includes a TAG index (TAGIndex-r19) to indicate the associated TAG (e.g., whether the first TAG, the second TAG is included in the PathlossReferenceRS-Config). An example is as follows:
PathlossReferenceRS-Config ::=CHOICE {
ssb-Index SSB-Index,
csi-RS-Index NZP-CSI-RS-ResourceId
TAGIndex-r19 INTEGER (0 . . . 1) OPTIONAL,—Need S
}

Here, rather than using a MAC CE 604, one or more RRC messages can be used. In particular, for each SRS resource set (SRS-ResourceSet), RRC associates each SRS-ResourceSet with a different PathlossReferenceRS-Config. As such, each SRS-ResourceSet is associated with a TAG index (whereby this TAG index is included in the PathlossReferenceRS-Config). The UE can receive this RRC signaling, determine a configured SRS-ResourceSet, determine that the SRS resource belongs to this set, determine the TAG index for this set, and, as such, determine the TA to use for transmitting the SRS resource. In this case, the network does not support transmission of a single SRS resource with two different TAGs.

In the case of the PUSCH resource, the power control configuration 610 corresponds to an SRS resource indicator for a PUSCH (SRI-PUSCH-PowerControl) and/or a PUSCH reference signal (RS) configuration for a pathloss reference (PUSCH-PathlossReferenceRS-Config). An IE can be added to the SRI-PUSCH-PowerControl and/or an IE can be added to PUSCH-PathlossReferenceRS-Config). In both cases, the IE includes a TAG index (TAGIndex-r19) to indicate the associated TAG (e.g., whether the first TAG, the second TAG is included in the SRI-PUSCH-PowerControl and/or whether the first TAG, the second TAG is included in the PUSCH-PathlossReferenceRS-Config).

An example of the SRI-PUSCH-PowerControl is as follows:
SRI-PUSCH-PowerControl ::=SEQUENCE {
sri-PUSCH-PowerControlId SRI-PUSCH-PowerControlId,
sri-PUSCH-PathlossReferenceRS-Id PUSCH-PathlossReferenceRS-Id,
sri-P0-PUSCH-AlphaSetId P0-PUSCH-AlphaSetId,
sri-PUSCH-ClosedLoopIndex ENUMERATED {i0, i1}
TAGIndex-r19 INTEGER (0 . . . 1) OPTIONAL,—Need S
}

An example of the PUSCH-PathlossReferenceRS-Config is as follows:
PUSCH-PathlossReferenceRS ::=SEQUENCE {
pusch-PathlossReferenceRS-Id PUSCH-PathlossReferenceRS-Id,
referenceSignal CHOICE {
ssb-Index SSB-Index,
csi-RS-Index NZP-CSI-RS-ResourceId
}
TAGIndex-r19 INTEGER (0 . . . 1) OPTIONAL,—Need S
}

Like the above examples, network signaling can be used to indicate (directly or indirectly) the TAG index given the SRI-PUSCH-PowerControl or PUSCH-PathlossReferenceRS-Config.

In an example, TAG applied for PUSCH can follow the TAG applied for SRS that is associated with the PUSCH. Accordingly, a PathlossReferenceRS-Config can be used to indicate TAG index for an SRS-ResourceSet. The SRI-PUSCH-PowerControl and the PUSCH-PathlossReferenceRS-Config need not indicate any TAG index. Instead, the relevant PUSCH transmission uses the TA corresponding to the TAG index indicated by the PathlossReferenceRS-Config of the SRS-ResourceSet.

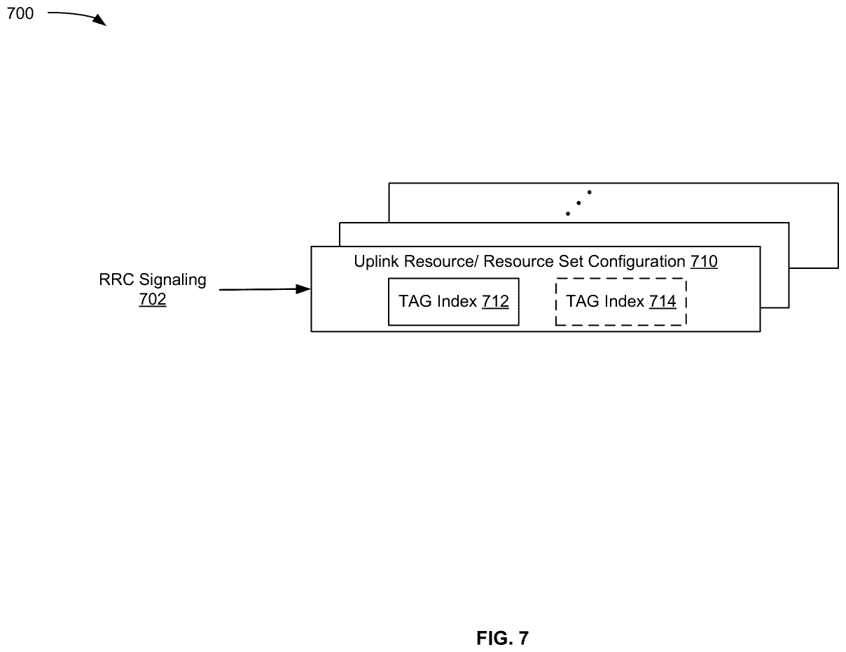

FIG. 7 illustrates another example 700 of configuring a UE to use multiple TAs, in accordance with some embodiments. In an example, a base station configures a UE by sending configuration information to the UE via RRC signaling 702. This configuration information can indicate multiple uplink resource configurations and/or multiple uplink resource set configurations (shown as multiples of uplink resource/resource set configuration 710). Each uplink resource/resource set configuration 710 can have an index and can include a particular IE specific for TAGs. The IE in the uplink resource/resource set configuration 710 can include a TAG index 712. As such, the uplink resource/resource set configuration 710 can directly link at least a TAG index to at least one uplink resource and/or uplink resource set.

In an example, once the UE is configured, the UE can be scheduled (e.g., via DCI, an uplink grant) to transmit an uplink resource. Given the corresponding uplink resource/resource set configuration 710, the UE can determine a TAG index included in the IE of this uplink resource/resource set configuration 710. Given the TAG index, the UE determines the corresponding TA to use and transmits the uplink resource based on this TA.

To illustrate, consider two examples applicable with a legacy TCI framework: a PUCCH resource and an SRS resource, and a PUSCH resource. In the examples, two TRPs and two TAGs are also illustrated. As far as the PUCCH resource, the base station can use RRC to explicitly configure TAGs. RRC signaling can configure either one TAG (and particular identify this TAG by its index, such that this identification corresponds to a network selection of one of the two TAGs) or both TAGs (shown in the figure as a TAG 712 and a TAG 714) per PUCCH resource or PUCCH resource set. Accordingly, when the UE needs to transmit a PUCCH resource, the UE can determine the applicable PUCCH resource/resource set configuration, determine therefrom the TAG index(es), and use the related TA(s) for the PUCCH uplink transmission(s).

As far as the SRS resource, the base station can use RRC to explicitly configure TAGs. RRC signaling can configure TAG (for SRS, only one TAG can be possible; this is illustrated in FIG. 7 by dashing the TAG index 714 to indicate that this TAG index 714 would not be used in SRS situations) per SRS resource or SRS resource set. Accordingly, when the UE needs to transmit an SRS resource, the UE can determine the applicable SRS resource/resource set configuration, determine therefrom the TAG index(es), and use the related TA(s) for the SRS uplink transmission(s).

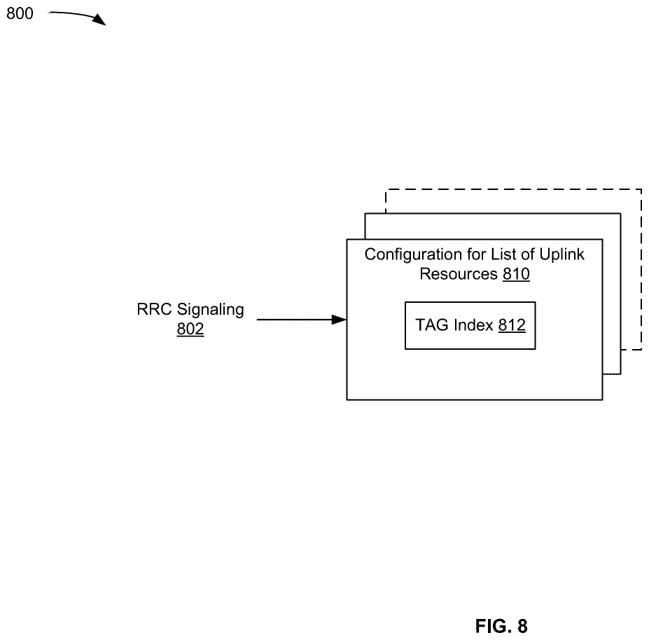

FIG. 8 illustrates another example 800 of configuring a UE to use multiple TAs, in accordance with some embodiments. In an example, a base station configures a UE by sending configuration information to the UE via RRC signaling 802. This configuration information can indicate multiple configurations, each being specific to a list of uplink resources and/or uplink resource sets (shown as multiples of a configuration 810 for a list of uplink resources). Each configuration 810 can have an index and can include a particular IE specific for TAGs. The IE in the configuration 810 can include a TAG index 812. As such, the configuration 810 can directly link at least a TAG index to at least a list of configured uplink resources and/or configured uplink resource sets.

In an example, once the UE is configured, the UE can be scheduled (e.g., via DCI, an uplink grant) to transmit an uplink resource. Given the corresponding configuration 810, the UE can determine a TAG index 812 included in the IE of this configuration 810. Given the TAG index 812, the UE determines the corresponding TA to use and transmits the uplink resource based on this TA.

To illustrate, consider two examples applicable with a legacy TCI framework: a PUCCH resource and an SRS resource. In these examples, two TRPs and two TAGs are also illustrated. As far as the PUCCH resource, the base station can use RRC to explicitly configure multiple lists of PUCCH resources. In each list, the RRC signaling can identify the applicable TAG index. For instance, the base station can configure three lists of PUCCH-resources. All the PUCCH resources indicated in the first list are configured to use a first configured TAG. All the PUCCH resources indicated in the second list are configured to use a second configured TAG. All the PUCCH resources indicated in the third list are configured to use both configured TAGs. Accordingly, when the UE needs to transmit a PUCCH resource, the UE can determine the applicable list, determine therefrom the TAG index(es), and use the related TA(s) for the PUCCH uplink transmission(s).

As far as the SRS resource, the base station can use RRC to explicitly configure multiple lists of SRS resource sets and/or SRS resources. For instance, RRC signaling can configure two lists. All the SRS resource sets and/or SRS resources indicated in the first list are configured to use a first configured TAG. All the SRS resource sets and/or SRS resources indicated in the second list are configured to use a second configured TAG. No third list is configured (this is shown in FIG. 8 by dashing the third list). Accordingly, when the UE needs to transmit an SRS resource, the UE can determine the applicable list, determine therefrom the TAG index, and use the related TA for the SRS uplink transmission.

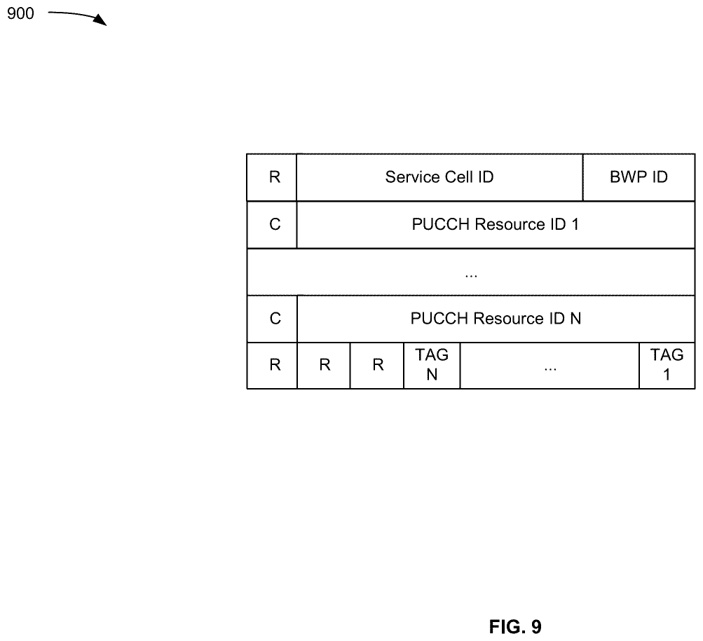

FIG. 9 illustrates an example of a media access control MAC CE 900 for indicating TAs to use with PUCCH transmissions, in accordance with some embodiments. Here, RRC signaling similar to the approaches of FIGS. 6-8 may, but need not, be used for configuring associations between uplink resources and TAGs. Instead, the MAC CE 900 itself can provide such associations. The MAC CE 900 can support a legacy TCI framework for a multi-TRP transmission using multiple TAGs (FIG. 9 describes the use of two configured TAGs, although a larger number is possible). The MAC CE 900 can explicitly activate one or two TAGs per PUCCH resource by using a “TAG” bit and a control “C” bit. The value of the “TAG” bit can indicate which of the two TAGs to use (e.g., a “0” indicates a first configured TAG, and a “1” indicates a second configured TAG). The value of the “C” bit can be considered as an override. Particularly, if the value of the “C” bit is “1,” for instance,” that means that both configured TAGs are to be used. Otherwise (e.g., a value of “0” for the “C” bit) means that the “TAG” bit controls.

In the illustration of FIG. 9, the MAC CE 900 includes a set of bits for the serving cell ID (e.g., the identity of the serving cell), a set of bits for BWP ID (e.g., the identity of the bandwidth part), a set of bits per PUCCH Resource ID (e.g., a PUCCH-ResourceId) to identify a PUCCH resource, a “C” bit per PUCCH resource ID, a “TAG” bit per PUCCH resource ID, and reserved “R” bits. For a PUCCH resource ID (e.g., say ID “1”), the corresponding “C” bit and “TAG” bit are used to explicitly activate one or both configured TAGS for the PUCCH resource having the PUCCH resource ID. If the “C” bit is set to “0,” one configured TAG is activated. This TAG is indicated by the “TAG” bit (e.g., if the “TAG” bit is set to “0,” then the first configured TAG is activated; otherwise, the second configured TAG is activated). If the “C” bit is set to “1,” both configured TAGs are activated, and the “TAG” bit can be omitted or ignored.

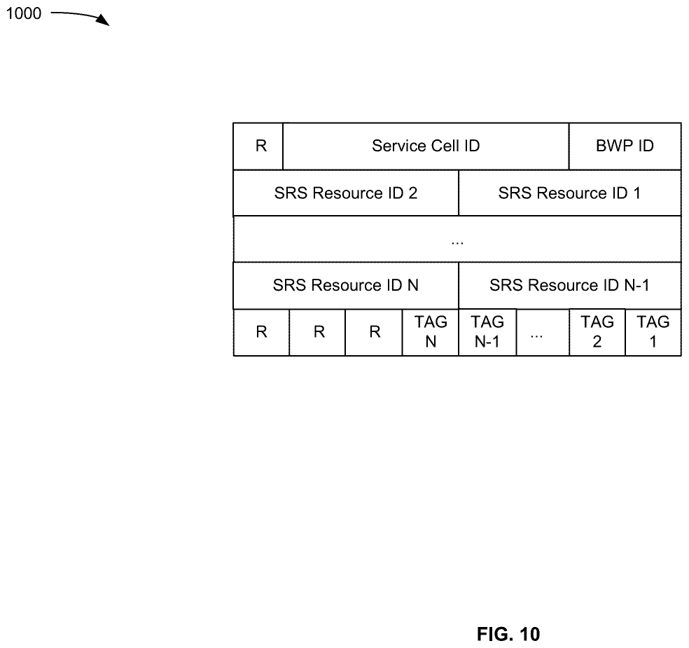

FIG. 10 illustrates an example of a MAC CE 1000 for indication TA to use with SRS transmissions, in accordance with some embodiments. Here, RRC signaling similar to the approaches of FIGS. 6-8 may, but need not, be used for configuring associations between uplink resources and TAGs. Instead, the MAC CE 1000 itself can provide such associations. The MAC CE 1000 can support a legacy TCI framework for a multi-TRP transmission using multiple TAGs (FIG. 10 describes the use of two configured TAGs, although a larger number is possible). The MAC CE 1000 can explicitly activate a TAG per SRS resource by using a “TAG” bit associated with the SRS resource. The value of the “TAG” bit can indicate which of the two TAGs to use (e.g., a “0” indicates a first configured TAG, and a “1” indicates a second configured TAG).

In the illustration of FIG. 10, the MAC CE 1000 includes a set of bits for the serving cell ID (e.g., the identity of the serving cell), a set of bits for BWP ID (e.g., the identity of the bandwidth part), a set of bits per SRS Resource Set ID (e.g., a SRS-ResourceSetId) to identify a resource set, a “TAG” bit per SRS Resource Set ID, and reserved “R” bits. For an SRS Resource Set ID (e.g., say ID “1”), the “TAG” bit is used to explicitly activate one of the two configured TAGS for an SRS resource that belongs to the SRS resource set (or for the entire SRS resource set. For instance, if the “TAG” bit is set to “0,” then the first configured TAG is activated. Otherwise, the second configured TAG is activated.

In an example, a UE can support one or more types of multi-TRP operation. For example, the UE can support single-DCI multi-TRP PUSCH/PUCCH repetition, single-DCI multi-TRP simultaneously transmission cross two panels (STx2P) spatial domain multiplexing (SDM) PUSCH, single-DCI multi-TRP STx2P single frequency network (SFN) PUSCH, and/or single-DCI multi-TRP STx2P SFN PUCCH. As far as the single-DCI multi-TRP PUSCH/PUCCH repetition, the UE can support repetition type A (e.g., a slot or sub-slot based repetition) or repetition type B: (e.g., back-to-back repetition). The UE can also support single-DCI multi-TRP UL operation with two or more TAs, for a unified TCI framework. The next figures describe approaches for this support.

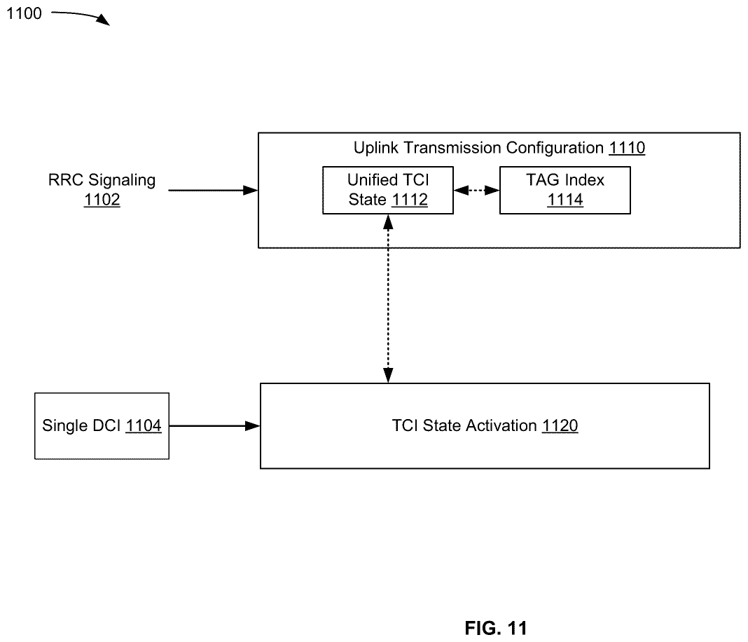

FIG. 11 illustrates an example 1100 of single-DCI in muti-TRP transmission indicating TAs to use, in accordance with some embodiments. In an example, a UE may be configured to use multiple TCI states, each of which may apply to a plurality of channels. Such a TCI state may be referred to herein as a unified TCI state.

A unified TCI state can be a joint TCI state usable for both downlink channels and uplink channels. Alternatively, the unified TCI state can be a downlink TCI state that can be used for downlink channels, an uplink TCI state that can be used for uplink channels. A plurality of such unified TCI states may be activated (e.g., via DCI or MAC CE).

In an example, a base station configures the UE by sending configuration information to the UE via RRC signaling 1102. This configuration information can indicate an uplink transmission configuration 1110 (e.g., for PUSCH and/or PUCCH transmissions). The transmission configuration 1110 can indicate a unified TCI state 1112 (multiple ones of such a state are possible) that can be a joint TCI state, a downlink TCI state, or an uplink TCI state. The transmission configuration 1110 can also indicate a TAG index 1114 (multiple ones of such an index are possible) that corresponds to one of multiple configured TAGs (e.g., to a first configured TAG or to second configured TAG). Further, the transmission configuration 1110 can associate the TAG index 1114 with the unified TCI state 1112. In the illustration of FIG. 11, the association is shown with a dotted, double-headed arrow.

Once configured, the UE can receive a single DCI 1104 for multi-TRP operation. This DCI can indicate a TCI state activation 1120, whereby at least one of the configured unified TCI states is activated. In the illustration of FIG. 11, the TCI state activation 1120 activates (as shown with the dotted, double-headed arrow) the unified TCI state 1112. Given the corresponding TAG index association, the single DCI 1104 indirectly indicates that the TAG index 1114 is to be used for the uplink channels to which the unified TCI state 1112 applies. Accordingly, the UE can determine whether to use the first configured TAG or the second configured TAG (although more than two TAGs may be configured) for the uplink transmissions on these channels (e.g., for the PUSCH and/or PUCCH transmissions).

The example 1100 of FIG. 11 is one approach for supporting the unified TCI framework. Other approaches for such a support are possible. For example, the approaches described in FIGS. 6-10 are also possible for the unified TCI framework.

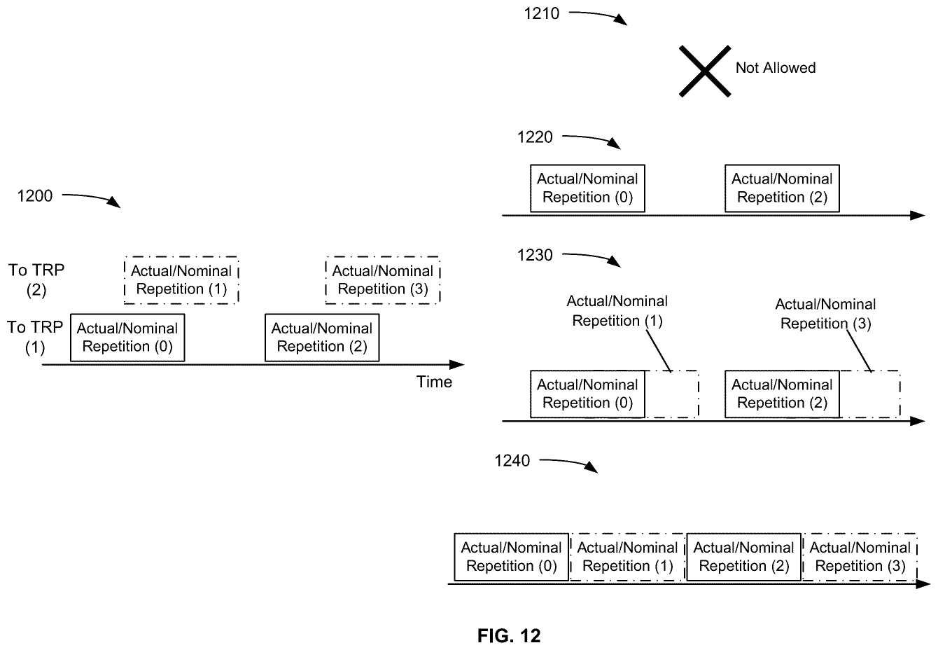

FIG. 12 illustrates examples of handling collisions due to the use of multiple TAs, in accordance with some embodiments. A UE can support single-DCI multi-TRP PUSCH/PUCCH repetition. On the left side of FIG. 12, an example 1200 of uplink resource (e.g., PUSCH and/or PUCCH) repetitions are illustrated. The solid rectangles correspond to uplink retransmissions to a first TRP (1) (shown as “actual/nominal repetition (0)” and “actual/nominal repetition (2)”). The dashed, dotted rectangles correspond to uplink retransmissions to a second TRP (2) (shown as “actual/nominal repetition (1)” and “actual/nominal repetition (3)”). A collision occurs when an uplink transmission to one of the two TRPs overlap at least partially in the time domain (e.g., by having an overlap of at least one symbol) with an uplink transmission to the other one of the two TRPs. In the example 1200, two collisions are illustrated: “actual/nominal repetition (1)” colliding with “actual/nominal repetition (0)” and “actual/nominal repetition (3)” colliding with “actual/nominal repetition (2).” Possible reasons for a collision can be the use of different Tas (e.g., when the TA used for TRP (2) is larger than the TA used for TRP (1), the collision of “actual/nominal repetition (1)” with “actual/nominal repetition (0)” and/or collision of “actual/nominal repetition (3)” with “actual/nominal repetition (2)” become possible).

On the right side of FIG. 12, examples of solutions to deal with collisions are illustrated. A first example 1210 is to avoid any collision. Particularly, for a UE that supports single-DCI multi-TRP UL operation with two or more TAs, for PUSCH/PUCCH repetition, a base station (or, more generally, the network) ensures that there is no collision due to different TAs between different repetitions. For instance, the base station can configure enough gap between adjacent repetitions. To illustrate, for Type A repetition, the gap can be at least one symbol long between two slots, where a first slot is used for the uplink transmission to the first TRP and the second slot is used for the up-link transmission to the second TRP. For type B repetition, the gap may be within a slot or within both slots. For example, at least one symbol (e.g., at the end of the first slot or at the start of the next adjacent slot) is configured as a blank symbol (e.g., a symbol that does not carry PUSCH and/or PUCCH information; the first thirteen symbols in the first slot can carry the first uplink transmission and/or the last thirteen symbols in the second, adjacent slot can carry the second uplink transmission). Accordingly, when the base station configures the uplink resources for the UE, and this configuration can indicate the start and/or end of symbols within a slot usable for an uplink transmission, where this configuration accounts for the gap. The base station can determine a collision that may actually occur due to the configured TAs and the scheduling of the uplink transmission. Or the base station can determine that the time difference between the configured TAs is smaller than a threshold (e.g., a percentage of the duration of the cyclic prefix) and, accordingly, configure the UE to avoid a possible collision.

In a second example 1220, the collision is permitted. For a UE that supports single-DCI multi-TRP UL operation with two or more TAs, for PUSCH/PUCCH repetition, the UE can drop a colliding uplink transmission completely. The UE can drop either the earlier colliding repetition or the later colliding repetition. In the illustration of FIG. 12, the dropping of the later collision is shown. In particular, the UE determines that “actual/nominal repetition (1)” collides with “actual/nominal repetition (0)” and “actual/nominal repetition (3)” collides with “actual/nominal repetition (2).” Accordingly, the UE drops “actual/nominal repetition (1)” and “actual/nominal repetition (3).” Dropping a repetition can involve the UE foregoing the corresponding uplink transmission through its RF chain or at baseband (e.g., by not processing the repetition). The UE can determine a collision that may actually occur due to the configured TAs and the scheduling of the uplink transmission. Or the UE can determine that the time difference between the configured TAs is smaller than a threshold (e.g., a percentage of the duration of the cyclic prefix) and, accordingly, determine that the later (or earlier) repetition is to be dropped.

In a third example 1230, the collision is also permitted. For a UE that supports single-DCI multi-TRP UL operation with two or more TAs, for PUSCH/PUCCH repetition, the UE can drop a colliding uplink transmission partially. The UE can partially drop either the earlier colliding repetition or the later colliding repetition. Partial dropping means that only the colliding symbols are dropped (e.g., the symbols found in the later or earlier slot and colliding with symbols of the other earlier or later slot). In the illustration of FIG. 12, the dropping of the later collision is shown. In particular, the UE determines that “actual/nominal repetition (1)” collides with “actual/nominal repetition (0)” and “actual/nominal repetition (3)” collides with “actual/nominal repetition (2).” Accordingly, the UE partially drops “actual/nominal repetition (1)” by only dropping the first initial symbols that collide with “actual/nominal repetition (0).” Similarly, the UE partially drops “actual/nominal repetition (3)” by only dropping the first initial symbols that collide with “actual/nominal repetition (2).” Dropping a symbol can involve the UE foregoing the corresponding uplink transmission through its RF chain or at baseband (e.g., by not processing the symbol).

In a fourth example 1240, the collision is mitigated. For a UE that supports single-DCI multi-TRP UL operation with two or more TAs, for PUSCH/PUCCH repetition, the UE can shift, in the time domain, a colliding uplink transmission such that the collision no longer occurs. Generally, the UE shifts the later colliding repletion by an integer number of symbols (e.g., one symbol, two symbols, etc.). The integer number of symbols can represent the smallest duration (that is a multiple of symbol durations) to avoid the collision. The delaying can be performed at baseband (e.g., by using a different starting symbol for the relevant uplink transmission). In the illustration of FIG. 12, the UE determines that “actual/nominal repetition (1)” collides with “actual/nominal repetition (0)” and “actual/nominal repetition (3)” collides with “actual/nominal repetition (2).” Accordingly, the UE delays the “actual/nominal repetition (1)” by a certain number of symbols so that it no longer collides with “actual/nominal repetition (0).” Similarly, the UE delays “actual/nominal repetition (3)” by a certain number of symbols so that it no longer collides with “actual/nominal repetition (2).”

In an example, to support single-DCI multi-TRP UL operation with two TAs, for single-DCI multi-TRP STx2P SDM PUSCH, single-DCI multi-TRP STx2P SFN PUSCH, and/or single-DCI multi-TRP STx2P SFN PUCCH, different approaches can be implemented. In an example approach, the use of two or more TAs is not allowed. For instance, the UE may not be configured to use more than TAG for a serving cell that has two or more TRPs. In another example approach, the use of two or more TAs can be allowed. Whether this use is allowed or not can depend on one or more factors. On example factor can be the time difference between two TAs. For instance, only when the time difference is within a threshold, the use of the two TAs can be permitted. In an illustration, the threshold can be a predefined default value or set as a percentage as a percentage of cyclic prefix duration (e.g., 50% of the CP). For each subcarrier spacing, the default value is predefined in a technical specification, or the CP duration is known from the technical specification. If the time difference is smaller than the applicable value given the SCS, the UE may not be allowed to use two TAs; Otherwise, the use is allowed. The allowed/disallowed state can be achieved via RRC (e.g., by configuring the UE to use two TAs or not) and/or via other network signaling (e.g., MAC CE or DCI). Another example factor is the UE capability. Particularly, the UE can additionally report whether UE supports two TAs operation for uplink scheduling (e.g., PUSCH and/or PUCCH scheduling), as described in FIG. 5. For instance, the UE reports whether it supports two or more TA. The UE also reports whether it supports single-DCI multi-TRP STx2P SDM PUSCH, single-DCI multi-TRP STx2P SFN PUSCH, and/or single-DCI multi-TRP STx2P SFN PUCCH. The UE further reports its supports of a combination of these two capabilities (e.g., whether the network can configure two or more TAs usable with single-DCI multi-TRP STx2P SDM PUSCH, single-DCI multi-TRP STx2P SFN PUSCH, and/or single-DCI multi-TRP STx2P SFN PUCCH). If the UE supports a combination, the base station can configure the UE to use two or more TAs (e.g., via RRC signaling) and can trigger their use via a single DCI.

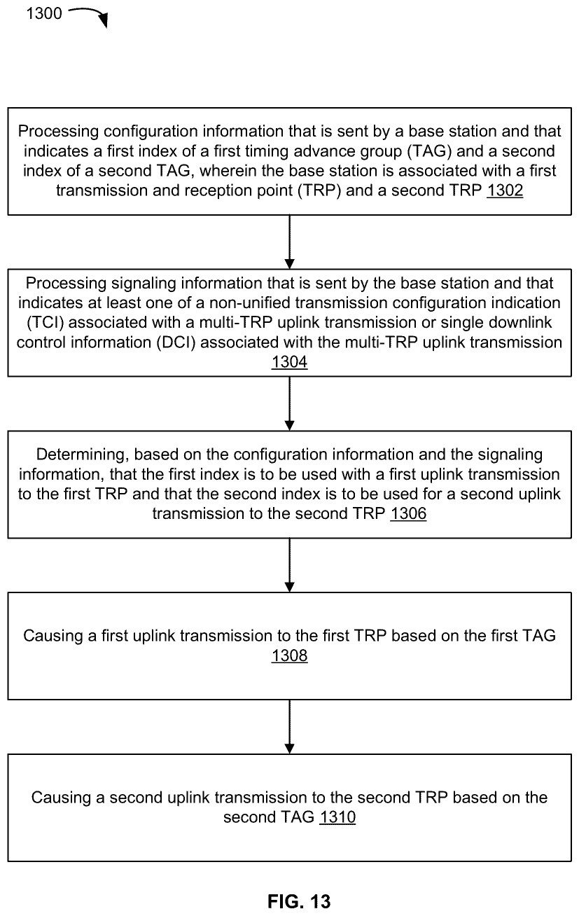

FIG. 13 illustrates an example of an operational flow/algorithmic structure 1300 for a UE to use multiple TAs, in accordance with some embodiments. The operation flow/algorithmic structure 1300 may be performed or implemented by the UE, such as any of the UEs described herein, or components thereof, for example, processors 1604.

The operation flow/algorithmic structure 1300 may include, at 1302, processing configuration information that is sent by a base station and that indicates a first index of a first timing advance group (TAG) and a second index of a second TAG, wherein the base station is associated with a first transmission and reception point (TRP) and a second TRP. For example, the configuration information corresponds to any of the configuration information described in FIGS. 6-11.

The operation flow/algorithmic structure 1300 may include, at 1304, processing signaling information that is sent by the base station and that indicates at least one of a non-unified transmission configuration indication (TCI) associated with a multi-TRP uplink transmission or single downlink control information (DCI) associated with the multi-TRP uplink transmission. For example, the signaling information corresponds to any of the MAC CEs or single DCIs described in FIGS. 6-11. In another example, the signaling information can correspond to one or more DCIs each having a format for scheduling uplink transmissions (including, for example, multi-DCIs for multi-TRP operations).

The operation flow/algorithmic structure 1300 may include, at 1306, determining, based on the configuration information and the signaling information, that the first index is to be used with a first uplink transmission to the first TRP and that the second index is to be used for a second uplink transmission to the second TRP. For example, the association between a configured uplink resource to be transmitted and a TAG index for a configured TAG is determined. This association can be directly indicated in the configuration information. In this case, the signaling information may be used to determine that the configured uplink transmission is scheduled but may not be used for the purpose of determining the association. Alternatively, the association can be indirectly indicated in the configuration information. In this case, the signaling information may be used to not only determine that the configured uplink transmission is scheduled, but also to determine the association.

The operation flow/algorithmic structure 1300 may include, at 1308, causing a first uplink transmission to the first TRP based on the first TAG. For example, relevant information from the configuration information and signaling information is processed by the UE (e.g., at a baseband processor thereof) to then schedule and send first uplink resources via a first RF chain (or at least a first antenna panel) of the UE.

The operation flow/algorithmic structure 1300 may include, at 1310, causing a second uplink transmission to the second TRP based on the second TAG. For example, relevant information from the configuration information and signaling information is processed by the UE (e.g., at a baseband processor thereof) to then schedule and send second uplink resources via a second RF chain (or at least a second antenna panel) of the UE.

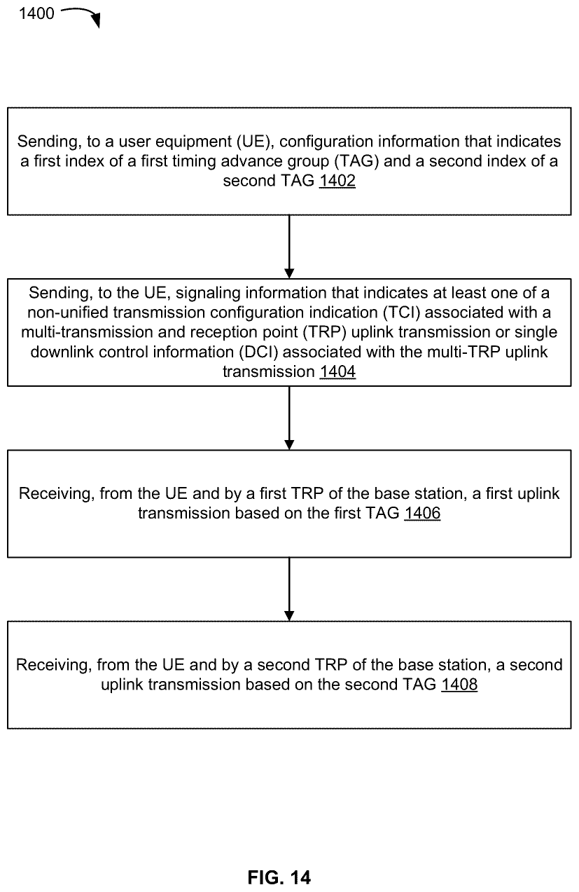

FIG. 14 illustrates an example of an operational flow/algorithmic structure 1400 for a base station to configure a UE to use multiple TAs, in accordance with some embodiments. The operation flow/algorithmic structure 1400 may be performed or implemented by the base station, such as any of the base station described herein, or components thereof, for example, processors 1704.

The operation flow/algorithmic structure 1400 may include, at 1402, sending, to a user equipment (UE), configuration information that indicates a first index of a first timing advance group (TAG) and a second index of a second TAG. For example, the configuration information corresponds to any of the configuration information described in FIGS. 6-11 and is sent using RRC signaling.

The operation flow/algorithmic structure 1400 may include, at 1404, sending, to the UE, signaling information that indicates at least one of a non-unified transmission configuration indication (TCI) associated with a multi-transmission and reception point (TRP) uplink transmission or single downlink control information (DCI) associated with the multi-TRP uplink transmission. For example, the signaling information corresponds to any of the MAC CEs or single DCIs described in FIGS. 6-11. In another example, the signaling information can correspond to one or more DCIs each having a format for scheduling uplink transmissions (including, for example, multi-DCIs for multi-TRP operations).

The operation flow/algorithmic structure 1400 may include, at 1406, receiving, from the UE and by a first TRP of the base station, a first uplink transmission based on the first TAG. For example, relevant information from the configuration information and signaling information is processed by the UE (e.g., at a baseband processor thereof) to then schedule and send first uplink resources via a first RF chain (or at least a first antenna panel) of the UE.

The operation flow/algorithmic structure 1400 may include, at 1408, receiving, from the UE and by a second TRP of the base station, a second uplink transmission based on the second TAG. For example, relevant information from the configuration information and signaling information is processed by the UE (e.g., at a baseband processor thereof) to then schedule and send second uplink resources via a second RF chain (or at least a second antenna panel) of the UE.

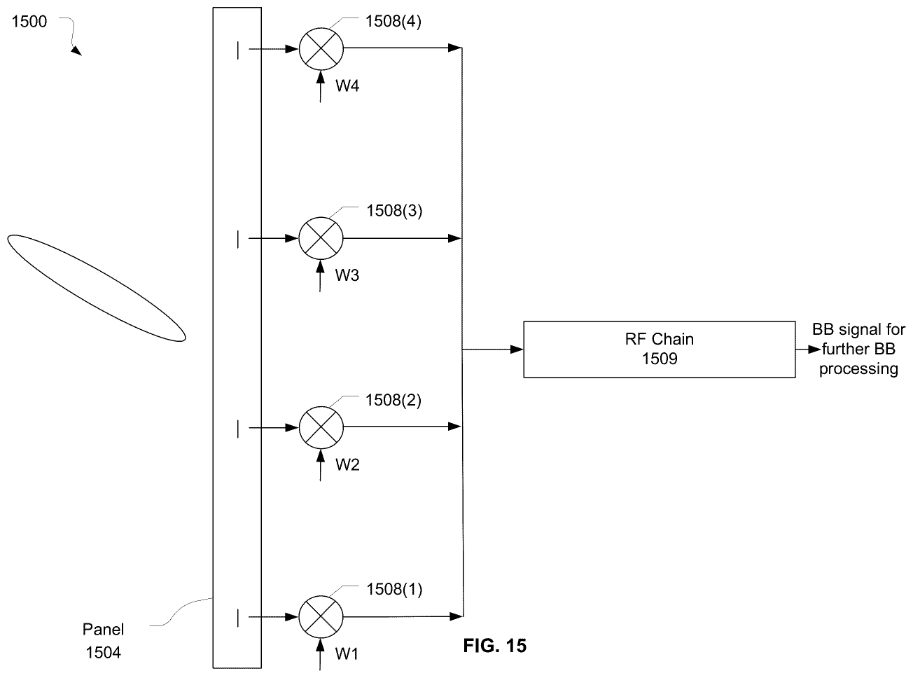

FIG. 15 illustrates receive components 1500 of a UE 104 (e.g., the UE 104 of FIG. 1 and any other UE described herein), in accordance with some embodiments. The receive components 1500 may include an antenna panel 1504 that includes a number of antenna elements. The panel 1504 is shown with four antenna elements, but other embodiments may include other numbers. Multiple antenna panels may also be included.

The antenna panel 1504 may be coupled to analog beamforming (BF) components that include a number of phase shifters 1508(1)-1508(4). The phase shifters 1508(1)-1508(4) may be coupled with a radio-frequency (RF) chain 1509. The RF chain 1509 may amplify a receive analog RF signal, down-convert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values to the phase shifters 1508(1)-1508(4) to provide a receive beam at the antenna panel 1504. These BF weights may be determined based on the channel-based beamforming.

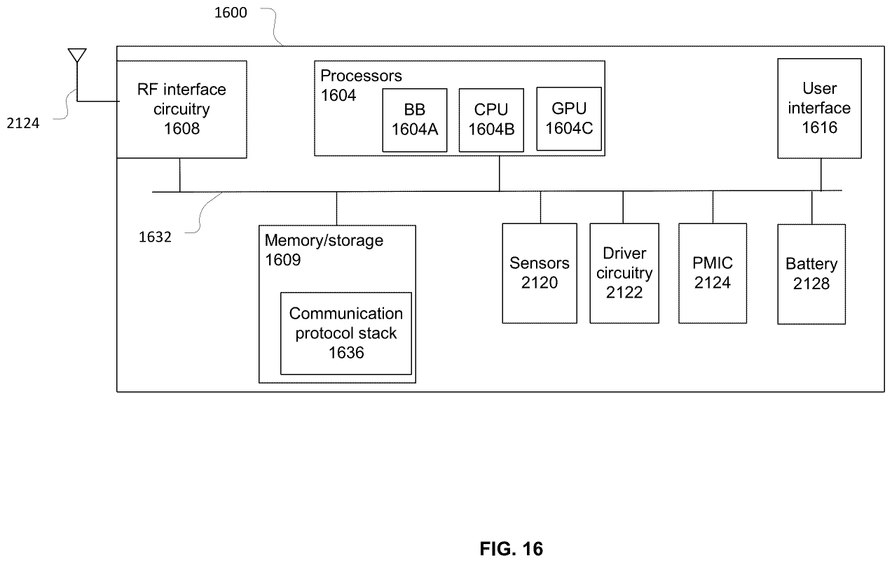

FIG. 16 illustrates a UE 1600, in accordance with some embodiments. The UE 1600 may be similar to and substantially interchangeable with the UE 104 of FIG. 1 and any other UE described herein.

Similar to that described above with respect to UE 104, the UE 1600 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, and actuators), video surveillance/monitoring devices (for example, cameras and video cameras), wearable devices, or relaxed-IoT devices. In some embodiments, the UE may be a reduced capacity UE or NR-Light UE.

The UE 1600 may include processors 1604, RF interface circuitry 1608, memory/storage 1609, user interface 1616, sensors 1620, driver circuitry 1622, power management integrated circuit (PMIC) 1624, and battery 1628. The components of the UE 1600 may be implemented as integrated circuits (ICs), portions thereof, discrete electronic devices, or other modules, such as logic, hardware, software, firmware, or a combination thereof. The block diagram of FIG. 16 is intended to show a high-level view of some of the components of the UE 1600. However, some of the components shown may be omitted, additional components may be present, and different arrangements of the components shown may occur in other implementations.

The components of the UE 1600 may be coupled with various other components over one or more interconnects 1632 which may represent any type of interface, input/output, bus (local, system, or expansion), transmission line, trace, optical connection, etc. that allows various circuit components (on common or different chips or chipsets) to interact with one another.

The processors 1604 may include processor circuitry, such as baseband processor circuitry (BB) 1604A, central processor unit circuitry (CPU) 1604B, and graphics processor unit circuitry (GPU) 1604C. The processors 1604 may include any type of circuitry or processor circuitry that executes or otherwise operates computer-executable instructions, such as program code, software modules, or functional processes from memory/storage 1609 to cause the UE 1600 to perform operations as described herein.

In some embodiments, the baseband processor circuitry 1604A may access a communication protocol stack 1636 in the memory/storage 1609 to communicate over a 3GPP compatible network. In general, the baseband processor circuitry 1604A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1608.

The baseband processor circuitry 1604A may generate or process baseband signals or waveforms that carry information in 3GPP-compatible networks. In some embodiments, the waveforms for NR may be based on cyclic prefix OFDM (CP-OFDM) in the uplink or downlink and discrete Fourier transform spread OFDM (DFT-S-OFDM) in the uplink.

The baseband processor circuitry 1604A may also access group information 1624 from memory/storage 1609 to determine search space groups in which a number of repetitions of a PDCCH may be transmitted.

The memory/storage 1612 may include any type of volatile or non-volatile memory that may be distributed throughout the UE 1600. In some embodiments, some of the memory/storage 1612 may be located on the processors 1604 themselves (for example, L1 and L2 cache), while other memory/storage 1612 is external to the processors 1604 but accessible thereto via a memory interface. The memory/storage 1612 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1608 may include transceiver circuitry and a radio frequency front module (RFEM) that allows the UE 1600 to communicate with other devices over a radio access network. The RF interface circuitry 1608 may include various elements arranged in transmit or receive paths. These elements may include switches, mixers, amplifiers, filters, synthesizer circuitry, control circuitry, etc.

In the receive path, the RFEM may receive a radiated signal from an air interface via an antenna 1624 and proceed to filter and amplify (with a low-noise amplifier) the signal. The signal may be provided to a receiver of the transceiver that down-converts the RF signal into a baseband signal that is provided to the baseband processor of the processors 1604.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1624.

In various embodiments, the RF interface circuitry 1608 may be configured to transmit/receive signals in a manner compatible with NR access technologies.

The antenna 1624 may include a number of antenna elements that each convert electrical signals into radio waves to travel through the air and to convert received radio waves into electrical signals. The antenna elements may be arranged into one or more antenna panels. The antenna 1624 may have antenna panels that are omnidirectional, directional, or a combination thereof to enable beamforming and multiple input multiple output communications. The antenna 1624 may include micro-strip antennas, printed antennas that are fabricated on the surface of one or more printed circuit boards, patch antennas, phased array antennas, etc. The antenna 1624 may have one or more panels designed for specific frequency bands including bands in FR1 or FR2.

The user interface circuitry 1616 includes various input/output (I/O) devices designed to enable user interaction with the UE 1600. The user interface 1616 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs)) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1600.

The sensors 1620 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example, cameras or lens-less apertures); light detection and ranging sensors; proximity sensors (for example, infrared radiation detector and the like); depth sensors; ambient light sensors; ultrasonic transceivers; microphones or other like audio capture devices; etc.

The driver circuitry 1622 may include software and hardware elements that operate to control particular devices that are embedded in the UE 1600, attached to the UE 1600, or otherwise communicatively coupled with the UE 1600. The driver circuitry 1622 may include individual drivers allowing other components to interact with or control various input/output (I/O) devices that may be present within or connected to the UE 1600. For example, driver circuitry 1622 may include a display driver to control and allow access to a display device, a touchscreen driver to control and allow access to a touchscreen interface, sensor drivers to obtain sensor readings of sensor circuitry 1620 and control and allow access to sensor circuitry 1620, drivers to obtain actuator positions of electro-mechanic components or control and allow access to the electro-mechanic components, a camera driver to control and allow access to an embedded image capture device, or audio drivers to control and allow access to one or more audio devices.

The PMIC 1624 may manage power provided to various components of the UE 1600. In particular, with respect to the processors 1604, the PMIC 1624 may control power-source selection, voltage scaling, battery charging, or DC-to-DC conversion.

In some embodiments, the PMIC 1624 may control, or otherwise be part of, various power saving mechanisms of the UE 1600. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1600 may power down for brief intervals of time and thus, save power. If there is no data traffic activity for an extended period of time, then the UE 1600 may transition off to an RRC_Idle state, where it disconnects from the network and does not perform operations, such as channel quality feedback, handover, etc. The UE 1600 goes into a very low power state, and it performs paging where again it periodically wakes up to listen to the network and then powers down again. The UE 1600 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay, and it is assumed the delay is acceptable.

A battery 1628 may power the UE 1600, although in some examples the UE 1600 may be mounted deployed in a fixed location and may have a power supply coupled to an electrical grid. The battery 1628 may be a lithium-ion battery, a metal-air battery, such as a zinc-air battery, an aluminum-air battery, a lithium-air battery, and the like. In some implementations, such as in vehicle-based applications, the battery 1628 may be a typical lead-acid automotive battery.

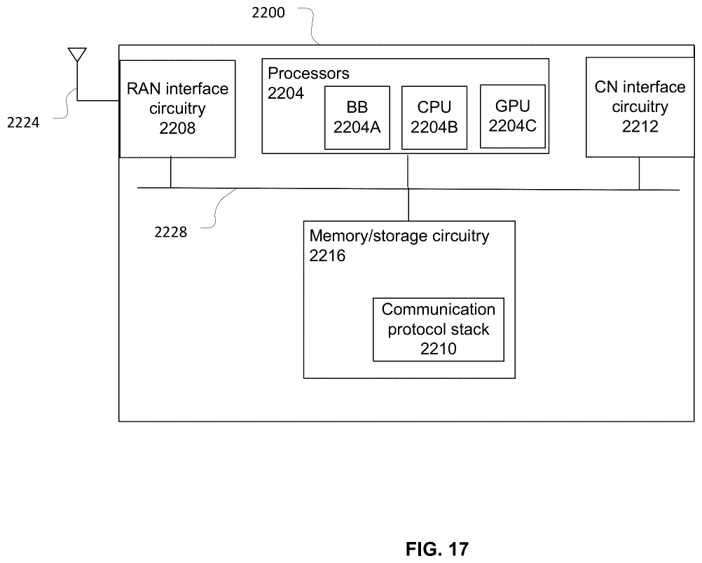

FIG. 17 illustrates a gNB 1700, in accordance with some embodiments. The gNB node 1700 may be similar to and substantially interchangeable with a base station (e.g., gNB 108) and/or components thereof can be included in a TRP.

The gNB 1700 may include processors 1704, RF interface circuitry 1708, core network (CN) interface circuitry 1712, and memory/storage circuitry 1716.

The components of the gNB 1700 may be coupled with various other components over one or more interconnects 1728.

The processors 1704, RF interface circuitry 1708, memory/storage circuitry 1716 (including communication protocol stack 1710), antenna 1724, and interconnects 1728 may be similar to like-named elements shown and described with respect to FIGS. 15 and 16.

The CN interface circuitry 1712 may provide connectivity to a core network, for example, a 5^{th} Generation Core network (5GC) using a 5GC-compatible network interface protocol, such as carrier Ethernet protocols or some other suitable protocol. Network connectivity may be provided to/from the gNB 1700 via a fiber optic or wireless backhaul. The CN interface circuitry 1712 may include one or more dedicated processors or FPGAs to communicate using one or more of the aforementioned protocols. In some implementations, the CN interface circuitry 1712 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate, in accordance with one or more of the examples set forth below. For another example, circuitry associated with a UE, base station, network element, etc., as described above in connection with one or more of the preceding figures, may be configured to operate in accordance with one or more of the examples set forth below in the example section.

### Examples

In the following sections, further exemplary embodiments are provided.

Example 1 includes a method implemented by a user equipment (UE), the method comprising: processing configuration information that is sent by a base station and that indicates a first index of a first timing advance group (TAG) and a second index of a second TAG, wherein the base station is associated with a first transmission and reception point (TRP) and a second TRP; processing signaling information that is sent by the base station and that indicates at least one of a non-unified transmission configuration indication (TCI) associated with a multi-TRP uplink transmission or single downlink control information (DCI) associated with the multi-TRP uplink transmission; determining, based on the configuration information and the signaling information, that the first index is to be used with a first uplink transmission to the first TRP and that the second index is to be used for a second uplink transmission to the second TRP; causing a first uplink transmission to the first TRP based on the first TAG; and causing a second uplink transmission to the second TRP based on the second TAG.

Example 2 includes a method implemented by a base station, the method comprising: sending, to a user equipment (UE), configuration information that indicates a first index of a first timing advance group (TAG) and a second index of a second TAG; sending, to the UE, signaling information that indicates at least one of a non-unified transmission configuration indication (TCI) associated with a multi-transmission and reception point (TRP) uplink transmission or single downlink control information (DCI) associated with the multi-TRP uplink transmission; receiving, from the UE and by a first TRP of the base station, a first uplink transmission based on the first TAG; and receiving, from the UE and by a second TRP of the base station, a second uplink transmission based on the second TAG.

Example 3 includes the method of any preceding example, wherein the configuration information indicates a spatial relation configuration for the multi-TRP uplink transmission in a frequency range between 24.25 GHz and 52.6 GHz, and wherein the first index and the second index are associated with the spatial relation configuration.

Example 4 includes the method of any preceding example, wherein the configuration information indicates a power control configuration for the multi-TRP uplink transmission, and wherein the first index and the second index are associated with the power control configuration.

Example 5 includes the method of example 4, wherein the power control configuration includes physical uplink control channel (PUCCH) power control set information (PUCCH-PowerControlSetInfo), and wherein an information element (IE) of the PUCCH-PowerControlSetInfo includes the first index.

Example 6 includes the method of example 5, wherein the signaling information includes a media access control (MAC) control element (CE) that indicates PUCCH-PowerControlSetInfo for transmitting a PUCCH resource, wherein the first index is determined from the PUCCH-PowerControlSetInfo based on the MAC CE information, and wherein the first uplink transmission includes a transmission of the PUCCH resource.

Example 7 includes the method of example 4, wherein the power control configuration includes reference signal (RS) configuration for a pathloss reference (PathlossReferenceRS-Config) information associated with a sound reference signal (SRS) resource set, and wherein an information element (IE) of the PathlossReferenceRS-Config information includes the first index.

Example 8 includes the method of example 7, wherein the first index is determined from the PathlossReferenceRS-Config information, and wherein the first uplink transmission includes a transmission of an SRS resource.

Example 9 includes the method of example 7, wherein the first index is determined from the PathlossReferenceRS-Config information, and wherein the first uplink transmission includes a transmission of a physical uplink shared channel (PUSCH) resource.

Example 10 includes the method of example 4, wherein the power control configuration includes sounding reference signal (SRS) resource indicator (SRI) for a physical uplink shared channel (PUSCH) and configuration of SRI to PUSCH power control configuration mapping (SRI-PUSCH-PowerControl) information or PUSCH reference signal (RS) configuration for a pathloss reference (PUSCH-PathlossReferenceRS-Config) information, and wherein an information element (IE) of the SRI-PUSCH-PowerControl information or the PUSCH-PathlossReferenceRS-Config information includes the first index.

Example 11 includes the method of any preceding example, wherein the configuration information is received based on radio resource control (RRC) signaling, indicates a configuration of an uplink resource or an uplink resource set, and associates the first index with the configuration, wherein the uplink resource is at least one of a physical uplink control channel (PUCCH) resource or a sounding reference (SRS) resource, and wherein the uplink resource set is at least one of a PUCCH resource set or an SRS resource set.

Example 12 includes the method of any preceding example 1-10, wherein the configuration information is received based on radio resource control (RRC) signaling, indicates a first configuration of a first list of physical uplink control channel (PUCCH) resources, a second configuration of a second list of PUCCH resources, and a third configuration of a third list of PUCCH resources, and associates the first index with the first list, the second index with the second list, and the first index and the second index with the third list.

Example 13 includes the method of any preceding example 1-10, wherein the signaling information includes a media access control (MAC) control element (CE) that identifies a first physical uplink control channel (PUCCH) resource to be transmitted and indicates whether the first PUCCH resource is associated with the first index only, or the second index only, or both the first index and the second index.

Example 14 includes the method of example of any preceding example 1-10, wherein the configuration information is received based on radio resource control (RRC) signaling, indicates a first configuration of a first list of sounding reference signal (SRS) resources and a second configuration of a second list of SRS resources, and associates the first index with the first list only and the second index with the second list only.

Example 15 includes the method of any preceding example 1-10, wherein the signaling information includes a media access control (MAC) control element (CE) that identifies a first sounding reference signal (SRS) resource set and a second SRS resource set and indicates that the first SRS resource set is associated with the first index only and that the second SRS resource set is associated with the second index only.

Example 16 includes the method of any preceding example, wherein the single DCI associates the first index with an uplink joint TCI state.

Example 17 includes the method of any preceding example, further comprising: determining that the first index is to be used with a third uplink transmission to the first TRP and that the second index is to be used with a fourth uplink transmission to the second TRP; determining a collision between the third uplink transmission and the fourth uplink transmission based on the first TAG and the second TAG; causing the third uplink transmission to the first TRP; and causing the third uplink transmission to be dropped.

Example 18 includes the method of any preceding example 1-16, further comprising: determining that the first index is to be used with a third uplink transmission to the first TRP and that the second index is to be used with a fourth uplink transmission to the second TRP; determining that a first set of symbols of the fourth uplink transmission collides with the third uplink transmission; causing the third uplink transmission to the first TRP; and causing a remaining set of symbols of the fourth uplink transmission to be transmitted and the first set of symbols to be dropped.

Example 19 includes the method of any preceding example 1-16, further comprising: determining that the first index is to be used with a third uplink transmission to the first TRP and that the second index is to be used with a fourth uplink transmission to the second TRP; determining a collision between the third uplink transmission and the fourth uplink transmission based on the first TAG and the second TAG; determining a delay for the fourth uplink transmission such that the collision is avoided; causing the third uplink transmission to the first TRP; and causing the fourth uplink transmission to be transmitted based on the delay.

Example 20 includes the method of any preceding example, further comprising: causing a transmission of capability information to the base station, wherein the capability information indicates that a UE supports the single DCI for the multi-TRP uplink transmission and supports multiple TAGs, and wherein the capability information further indicates whether the UE supports the multiple TAGs in association with the single DCI.

Example 21 includes the method of any preceding example, further comprising: determining a gap between a third uplink transmission that uses the first TAG and a fourth uplink transmission that uses the second TAG such that a collision between the third uplink transmission and the fourth uplink transmission is avoided, wherein the signaling information schedules the third uplink transmission and the fourth uplink transmission based on the gap.

Example 22 includes the method of any preceding example, further comprising: determining a time difference between a first timing advance (TA) associated with the first TAG and a second TA associated with the second TAG, wherein the time difference indicates that the multi-TRP uplink transmission is using the first TA and the second TA is allowed, and wherein the configuration information is sent based on the time difference.

Example 23 includes a user equipment (UE) comprising: one or more processors; and one or more memory storing instructions that, upon execution by the one or more processors, configure the UE to perform the method of any preceding example.

Example 24 includes one or more computer-readable media storing instructions that, when executed on a user equipment (UE), cause the UE to perform operations comprising those of the method of any preceding example.

Example 25 includes a device comprising means to perform one or more elements of a method described in or related to any of the preceding examples.

Example 26 includes one or more non-transitory computer-readable media comprising instructions to cause a device, upon execution of the instructions by one or more processors of the device, to perform one or more elements of a method described in or related to any of the preceding examples.

Example 27 includes a device comprising logic, modules, or circuitry to perform one or more elements of a method described in or related to any of the preceding examples.

Example 28 includes a device comprising: one or more processors and one or more computer-readable media comprising instructions that, when executed by the one or more processors, cause the one or more processors to perform one or more elements of a method described in or related to any of the preceding examples.

Example 29 includes a system comprising means to perform one or more elements of a method described in or related to any of the preceding examples.

Example 30 includes an apparatus comprising: processing circuitry to perform one or more elements of the method described in or related to any of the preceding examples, or any other method or process describe herein; and interface circuitry, coupled with the processing circuitry, the interface circuitry to communicatively couple the processing circuitry to one or more components of a computing platform.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

Applicant hereby claims:

1. An apparatus comprising:
processing circuitry configured to:
process configuration information that is sent by a base station and that indicates a first index of a first timing advance group (TAG) and a second index of a second TAG, wherein the base station is associated with a first transmission and reception point (TRP) and a second TRP;
process signaling information that is sent by the base station and that indicates at least one of a non-unified transmission configuration indication (TCI) associated with a multi-TRP uplink transmission or single downlink control information (DCI) associated with the multi-TRP uplink transmission;
determine, based on the configuration information and the signaling information, that the first index is to be used with a first uplink transmission to the first TRP and that the second index is to be used for a second uplink transmission to the second TRP;
cause a first uplink transmission to the first TRP based on the first TAG; and
cause a second uplink transmission to the second TRP based on the second TAG.

2. The apparatus of claim 1, wherein the configuration information indicates a spatial relation configuration for the multi-TRP uplink transmission in a frequency range between 24.25 GHz and 52.6 GHz, and wherein the first index and the second index are associated with the spatial relation configuration.

3. The apparatus of claim 1, wherein the configuration information indicates a power control configuration for the multi-TRP uplink transmission, and wherein the first index and the second index are associated with the power control configuration.

4. The apparatus of claim 3, wherein the power control configuration includes physical uplink control channel (PUCCH) power control set information (PUCCH-PowerControlSetInfo), and wherein an information element (IE) of the PUCCH-PowerControlSetInfo includes the first index.

5. The apparatus of claim 3, wherein the power control configuration includes reference signal (RS) configuration for a pathloss reference (PathlossReferenceRS-Config) information associated with a sound reference signal (SRS) resource set, and wherein an information element (IE) of the PathlossReferenceRS-Config information includes the first index.

6. The apparatus of claim 3, wherein the power control configuration includes sounding reference signal (SRS) resource indicator (SRI) for a physical uplink shared channel (PUSCH) and configuration of SRI to PUSCH power control configuration mapping (SRI-PUSCH-PowerControl) information or PUSCH reference signal (RS) configuration for a pathloss reference (PUSCH-PathlossReferenceRS-Config) information, and wherein an information element (IE) of the SRI-PUSCH-PowerControl information or the PUSCH-PathlossReferenceRS-Config information includes the first index.

7. The apparatus of claim 1, wherein the configuration information is received based on radio resource control (RRC) signaling, indicates a configuration of an uplink resource or an uplink resource set, and associates the first index with the configuration, wherein the uplink resource is at least one of a physical uplink control channel (PUCCH) resource or a sounding reference (SRS) resource, and wherein the uplink resource set is at least one of a PUCCH resource set or an SRS resource set.

8. The apparatus of claim 1, wherein the configuration information is received based on radio resource control (RRC) signaling, indicates a first configuration of a first list of physical uplink control channel (PUCCH) resources, a second configuration of a second list of PUCCH resources, and a third configuration of a third list of PUCCH resources, and associates the first index with the first list, the second index with the second list, and the first index and the second index with the third list.

9. The apparatus of claim 1, wherein the signaling information includes a media access control (MAC) control element (CE) that identifies a first physical uplink control channel (PUCCH) resource to be transmitted and indicates whether the first PUCCH resource is associated with the first index only, or the second index only, or both the first index and the second index.

10. The apparatus of claim 1, wherein the configuration information is received based on radio resource control (RRC) signaling, indicates a first configuration of a first list of sounding reference signal (SRS) resources and a second configuration of a second list of SRS resources, and associates the first index with the first list only and the second index with the second list only.

11. The apparatus of claim 1, wherein the signaling information includes a media access control (MAC) control element (CE) that identifies a first sounding reference signal (SRS) resource set and a second SRS resource set and indicates that the first SRS resource set is associated with the first index only and that the second SRS resource set is associated with the second index only.

12. One or more computer-readable storage media instructions that, upon execution by one or more processors, cause the one or more processors to perform operations comprising:
processing configuration information that is sent by a base station and that indicates a first index of a first timing advance group (TAG) and a second index of a second TAG, wherein the base station is associated with a first transmission and reception point (TRP) and a second TRP;
processing signaling information that is sent by the base station and that indicates at least one of a non-unified transmission configuration indication (TCI) associated with a multi-TRP uplink transmission or single downlink control information (DCI) associated with the multi-TRP uplink transmission;
determining, based on the configuration information and the signaling information, that the first index is to be used with a first uplink transmission to the first TRP and that the second index is to be used for a second uplink transmission to the second TRP;
causing a first uplink transmission to the first TRP based on the first TAG; and
causing a second uplink transmission to the second TRP based on the second TAG.

13. The one or more computer-readable storage media of claim 12, wherein the single DCI associates the first index with an uplink joint TCI state.

14. The one or more computer-readable storage media of claim 12, wherein the operations further comprise:
determining that the first index is to be used with a third uplink transmission to the first TRP and that the second index is to be used with a fourth uplink transmission to the second TRP;
determining a collision between the third uplink transmission and the fourth uplink transmission based on the first TAG and the second TAG;
causing the third uplink transmission to the first TRP; and
causing the third uplink transmission to be dropped.

15. The one or more computer-readable storage media of claim 12, wherein the operations further comprise:
determining that the first index is to be used with a third uplink transmission to the first TRP and that the second index is to be used with a fourth uplink transmission to the second TRP;
determining that a first set of symbols of the fourth uplink transmission collides with the third uplink transmission;
causing the third uplink transmission to the first TRP; and
causing a remaining set of symbols of the fourth uplink transmission to be transmitted and the first set of symbols to be dropped.

16. The one or more computer-readable storage media of claim 12, wherein the operations further comprise:
determining that the first index is to be used with a third uplink transmission to the first TRP and that the second index is to be used with a fourth uplink transmission to the second TRP;
determining a collision between the third uplink transmission and the fourth uplink transmission based on the first TAG and the second TAG;
determining a delay for the fourth uplink transmission such that the collision is avoided;
causing the third uplink transmission to the first TRP; and
causing the fourth uplink transmission to be transmitted based on the delay.

17. The one or more computer-readable storage media of claim 12, wherein the operations further comprise:
causing a transmission of capability information to the base station, wherein the capability information indicates that a UE supports the single DCI for the multi-TRP uplink transmission and supports multiple TAGs, and wherein the capability information further indicates whether the UE supports the multiple TAGs in association with the single DCI.

18. A method comprising:
sending, to a user equipment (UE), configuration information that indicates a first index of a first timing advance group (TAG) and a second index of a second TAG;
sending, to the UE, signaling information that indicates at least one of a non-unified transmission configuration indication (TCI) associated with a multi-transmission and reception point (TRP) uplink transmission or single downlink control information (DCI) associated with the multi-TRP uplink transmission;
processing first information corresponding to a first uplink transmission received from the UE by a first TRP of the base station, the first uplink transmission based on the first TAG; and
processing second information corresponding to a first uplink transmission received from the UE by a second TRP of the base station, the second uplink transmission based on the second TAG.

19. The method of claim 18, further comprising:
determining a gap between a third uplink transmission that uses the first TAG and a fourth uplink transmission that uses the second TAG such that a collision between the third uplink transmission and the fourth uplink transmission is avoided, wherein the signaling information schedules the third uplink transmission and the fourth uplink transmission based on the gap.

20. The method of claim 18, further comprising:
determining a time difference between a first timing advance (TA) associated with the first TAG and a second TA associated with the second TAG, wherein the time difference indicates that the multi-TRP uplink transmission is using the first TA and the second TA is allowed, and wherein the configuration information is sent based on the time difference.
